(19) United States
(12) Patent Application Publication
(10) Pub. No.: US 2018/0239277 A1
(43) Pub. Date: Aug. 23, 2018

(54) IMAGE FORMING APPARATUS

(71) Applicant: CANON KABUSHIKI KAISHA, Tokyo (JP)

(72) Inventor: Jun Shirayanagi, Ushiku-shi (JP)

(21) Appl. No.: 15/873,130

(22) Filed: Jan. 17, 2018

(30) Foreign Application Priority Data
Jan. 18, 2017 (JP) 2017-006987

(51) Int. Cl. G03G 15/08

(52) U.S. Cl. CPC G03G 15/0868; G03G 15/0886; G03G 2215/0692; G03G 15/0889; G03G 15/0882

(57) ABSTRACT

An image forming apparatus includes a developing device detachably mountable to an image forming apparatus; a supplying device including an accommodating portion for accommodating a developer supplied from a developer container accommodating the developer, the supplying device being effective to supply the developer accommodated in the accommodating portion into the developing device; a controller for controlling the supply of the developer from the supplying device into the developing device; a communicating portion provided in the supplying device, for fluid communication between the accommodating portion and the developing device; a seal provided at the communicating portion to hermetically confining the developer in the accommodating portion before an operation of image forming apparatus; and a removing portion for receiving a driving force from the image forming apparatus to wind the seal up to permit fluid communication between the accommodating portion and the developing device.

### FIELD OF THE INVENTION AND RELATED ART

The present invention relates to such image forming apparatuses as a copying machine, a printing machine, a facsimileing machine, and a multifunction machine capable of functioning as two or more of the preceding machines, that employ an electrophotographic image forming method or an electrostatic recording method.

An image forming apparatus which uses an electrophotographic image forming method or an electrophotographic recording method employs a developing apparatus which uses developer to develop an electrostatic latent image formed on an image bearing member. This type of image forming apparatus is provided with a system for replenishing a developing apparatus with developer by an amount equivalent to the amount by which developer is consumed for development. There has been known an image forming apparatus structured so that replenishment developer is supplied to its developing apparatus from its developer container in which replenishment developer is stored, or a replenishing apparatus (hopper unit) for controlling the amount by which a developing apparatus is replenished with replenishment developer is disposed between its developer container and developing apparatus. Generally speaking, an image forming apparatus which uses an electrophotographic image forming method or an electrostatic recording method is structured so that a developer container is removably mountable in the main assembly of the apparatus, in order to enable a user to repeatedly replace the developer container in the main assembly throughout the life span of the image forming apparatus or the developing apparatus thereof. Further, some image forming apparatuses are structured so that their developing apparatus is also removably mountable in their main assembly for maintenance or replacement.

The developing apparatus of an image forming apparatus of a certain type is shipped from its manufacturer without being filled with developer. Thus, when this type of image forming apparatus is used for the first time, its developing apparatus has to be supplied with developer (initial supply of developer). As a method for supplying the developing apparatus of this type of image forming apparatus with developer (initial supply of developer), the following has been known.

According to the method disclosed in Japanese Laid-open Patent Application No. 2006-195343, before the image forming apparatus is shipped, its developer container is filled with developer; the developer passage between the developer container and developer is sealed with a sealing member; and the developer container is mounted in the image forming apparatus. Then, the image forming apparatus is shipped. In the case of this method, when the image forming apparatus is used for the first time, the sealing member of the developer container has to be manually removed by a user to establish a developer passage between the developer container and developing apparatus.

According to the method disclosed in Japanese Laid-open Patent Application No. 2005-189423, before the image forming apparatus is shipped, its developing apparatus is filled with an initial supply of developer; the developer passage between the developing apparatus and developer replenishing apparatus is sealed with a sealing member; and the developing apparatus is mounted in the main assembly of the image forming apparatus. Then, the apparatus is shipped. In the case of this method, when the image forming apparatus is initialized for the first time, the sealing member of the developing apparatus is to be manually removed to unseal the developer passage between the replenishing apparatus and developing apparatus.

As described above, there are the method for shipping the image forming apparatus after the mounting of the developer container filled with developer into the main assembly of the image forming apparatus, and the method for shipping the image forming apparatus after mounting of the developing apparatus filled with developer into the main assembly of the image forming apparatus. Generally speaking, however, an image forming apparatus having a replenishing apparatus is shipped without filling the replenishing apparatus with developer. Then, when the image forming apparatus is initialized for the first time, its replenishing apparatus is supplied (filled) with developer from the developer container.

However, in a case where an image forming apparatus is shipped without filling the replenishing apparatus with developer, its replenishing apparatus has to be supplied (filled) with developer from a developer container when the image forming apparatus is initialized for the first time. Thus, it takes a substantial length of time to initialize the image forming apparatus for the first time.

### SUMMARY OF THE INVENTION

Thus, the primary object of the present invention is to provide an image forming apparatus which has an apparatus for replenishing a developing apparatus with developer, and yet, is significantly shorter in the length of time it takes for the replenishing apparatus to be supplied with developer when the image forming apparatus is initialized for the first time, than any conventional image forming apparatus having a replenishing apparatus.

According to an aspect of the present invention, there is provided an image forming apparatus, comprising a developing device configured to develop an electrostatic latent image formed on an image bearing member, said developing device being detachably mounted to an image forming apparatus; a supplying device including an accommodating portion configured to accommodate a developer supplied from a developer container accommodating the developer, said supplying device being configured to supply the developer accommodated in said accommodating portion into said developing device; a controller configured to control the supply of the developer from said supplying device into said developing device; a communicating portion provided in said supplying device and configured for fluid communication between said accommodating portion and said developing device; a seal provided at said communicating portion to hermetically confining the developer in said accommodating portion before an operation of image forming apparatus; and a removing portion configured to receive a driving force from said image forming apparatus to wind said seal up to permit fluid communication between said accommodating portion and said developing device.

Further features of the present invention will become apparent from the following description of exemplary embodiments with reference to the attached drawings.

### BRIEF DESCRIPTION OF THE DRAWINGS

FIG. 1 is a schematic sectional view of the image forming apparatus in the first embodiment of the present invention.

FIG. 2 is a schematic sectional view of the developing apparatus, and its adjacencies, of the image forming apparatus in the first embodiment.

FIG. 3 is a schematic sectional view of the hopper unit, and its adjacencies, of the image forming apparatus in the first embodiment.

Part (a) of FIG. 4 is a schematic sectional view of the hopper unit of the image forming apparatus in the first embodiment; it shows how and where the hopper unit is kept sealed, and part (b) of FIG. 4 is a top view of the hopper unit; it shows how and where the unit is kept sealed.

FIG. 5 is a flowchart of the sequence for initializing the hopper unit.

FIG. 6 is a schematic sectional view of in the second embodiment of the present invention.

Parts (a) and (b) of FIG. 7 are schematic sectional views of the hopper unit in the second embodiment; they are for showing how and where the hopper unit is kept sealed and how the sealing member of the hopper unit is utilizing as a stirring member.

### DESCRIPTION OF THE EMBODIMENTS

Hereinafter, the image forming apparatuses in accordance with the present invention are described in greater detail with reference to appended drawings.

### Embodiment 1

### 1. Overall Structure and Operation of Image Forming Apparatus

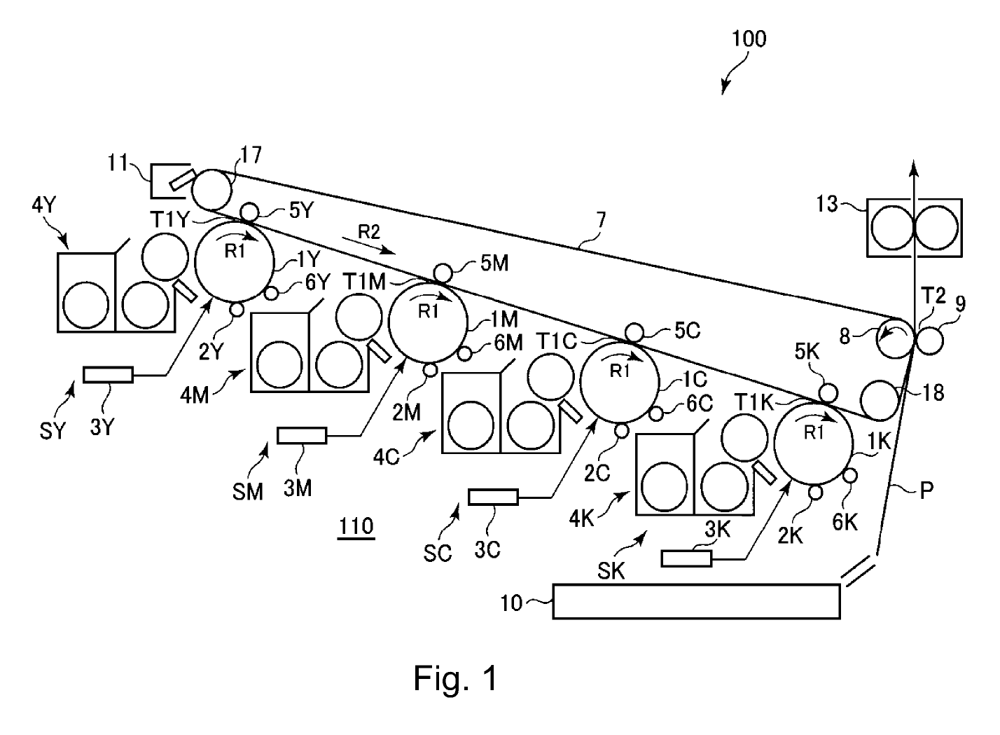

FIG. 1 is a schematic sectional view of the image forming apparatus in this embodiment. The image forming apparatus 100 in this embodiment is an electrophotographic full-color image forming apparatus. It is a multifunction apparatus capable of functioning as a copying machine, a printing machine, and a facsimileing machine. It is an image forming apparatus of the so-called intermediary transfer type, and also, of the so-called tandem type.

The image forming apparatus 100 has multiple image forming portions (image forming stations), more specifically, the first, second, third, and fourth image forming portions SY, SM, SC and SK, which form yellow (Y), magenta (M), cyan (C) and black (K) images, respectively. In this embodiment, the four image forming portions SY, SM, SC and SK are practically the same in structure and operation, although they are different in the color of the toner they use in their development process, which will be described later. Thus, unless they need to be differentiated for specific reasons, suffixes Y, M, C and K, which indicate the color components of which a full-color image is formed by the image forming apparatus 100 are ignored, so that the four image forming sections can be described together. In this embodiment, an image forming section S has: a photosensitive drum 1, a charge roller 2, an exposing apparatus 3, a developing apparatus 4, the primary transfer roller 5, and an auxiliary charge roller 6, which are described later.

The photosensitive drum 1 is an image bearing member which bears a toner image. It is an electrophotographic photosensitive member, and is in the form of a drum (cylindrical). It is rotatable and is rotationally driven in the direction indicated by an arrow mark R1 in FIG. 1, at a preset peripheral velocity (process speed). As the photosensitive drum 1 is rotated, its peripheral surface is charged to a preset polarity (which is negative in this embodiment) and a potential level by the charge roller 2, which is a charging means and is in the form of a roller. The uniformly charged portion of the peripheral surface of the photosensitive drum 1 is scanned by (exposed to) a beam of laser light projected thereupon by an exposing apparatus 3 (laser scanner), as an exposing means, while being modulated according to the information of the image to be formed. Consequently, an electrostatic latent image is formed on the peripheral surface of the photosensitive drum 1. The electrostatic latent image formed on the peripheral surface of the photosensitive drum 1 is developed (into visible image, which hereafter is referred to toner image) by the developing apparatus 4, as a developing means, which uses developer. That is, a toner image is formed on the photosensitive drum 1. More specifically, in this embodiment, the image forming apparatus 100 is designed so that as a given point of the uniformly charged portion of the peripheral surface of the photosensitive drum 1 is exposed after being charged to the preset level, the point reduces in the absolute value of its charge. It is to this point that toner charged to the same polarity as the polarity (which is negative in this embodiment) to which the peripheral surface of the photosensitive drum 1 has been charged, adheres. In this embodiment, the normal polarity to which toner becomes charged during a development process is negative. The developing apparatus 4 is described later in greater detail.

The image forming apparatus 100 is provided with an intermediary transfer belt 7, as an intermediary transferring member, which is disposed so that it opposes each of the four photosensitive drums 1. The intermediary transfer belt 7 is an endless belt. It is suspended and kept tensioned by multiple belt suspending rollers, more specifically, a belt-backing roller 8, a tension roller 17, and an idler roller 18 in such a manner that it bridges the adjacent two rollers. The image forming apparatus 100 is structured so that the belt-backing roller 8 and the secondary transfer roller (which is described later) oppose each other with the presence of the intermediary transfer belt 7 between them. As the belt-backing roller 8, which doubles as a driver roller, is rotationally driven, the intermediary transfer belt 7 is rotated (circularly moved) by the belt-backing roller 8 in the direction (counterclockwise direction) indicated by an arrow mark R2 in the drawing, at roughly the same speed as the peripheral velocity of the photosensitive drum 1. There are disposed four primary transfer rollers 5, as the primary transferring means, on the inward side of the loop (belt loop) which the intermediary transfer belt 7 forms, in such a manner that they oppose the four photosensitive drums 1 one for one, with the presence of the intermediary transfer belt 7 between each primary transfer roller 5 and corresponding photosensitive drum 1. Each primary transfer roller 5 is kept pressed again the corresponding photosensitive drum 1 with the presence of the intermediary transfer belt 7 between them, forming thereby the primary transferring portion T (primary transfer nip), which is the area of contact between the photosensitive drum 1 and intermediary transfer belt 7. A toner image formed on the peripheral surface of the photosensitive drum 1 as described above is transferred (primary transfer) onto the intermediary transfer belt 7 by the function of the primary transfer roller 5, in the primary transferring portion T1. During the primary transfer, the primary transfer voltage, which is DC voltage, is applied to the primary transfer roller 5. The primary transfer voltage is opposite in polarity from the normal charge of toner. For example, when the image forming apparatus 100 is operated to form a full-color image, the yellow, magenta, cyan, and black toner images formed on the four photosensitive drums 1 one for one are sequentially transferred onto the intermediary transfer belt 7 so that they are layered on the intermediary transfer belt 7.

The image forming apparatus 100 is provided with the secondary transfer roller 9, as the secondary transferring member, which is the secondary transferring means. The secondary transfer roller 9 is disposed on the outward (outward surface) side of the loop (belt loop) which the intermediary transfer belt 7 forms, in such a position in which it opposes the belt-backing roller 8. The secondary transfer roller 9 is kept pressed against the belt-backing roller 8 with the presence of the intermediary transfer belt 7 between them, forming thereby the secondary transferring portion T2 (secondary transfer nip), which is the area of contact between the intermediary transfer belt and secondary transfer roller 9. A toner image formed on the intermediary transfer belt 7 as described above is transferred (secondary transfer) onto a sheet P of recording medium such as recording paper, in the secondary transferring portion T2, by the function of the secondary transfer roller 9, while the sheet P is conveyed, remaining pinched between the intermediary transfer belt 7 and secondary transfer roller 9. During the secondary transfer, the secondary transfer voltage, which is DC voltage, is applied to the secondary transfer roller 9. The secondary transfer voltage is opposite in polarity from the normal charge of toner. The image forming apparatus 100 is provided with a cassette 10 in which multiple sheets P of recording medium are stored in layers, and from which the sheets P are supplied to the secondary transferring portion T2 by a sheet-feeding-conveying apparatus (unshown) having a feed roller, conveyance rollers, registration rollers, etc.

After the transfer of a toner image onto a sheet P of recording medium, the sheet P is conveyed to a fixing apparatus 13 as a fixing means. In the fixing apparatus 13, the sheet P and the toner image thereon are heated and pressed. Thus, the toner image becomes fixed (welded) to the sheet P. After being conveyed through the fixing apparatus 13, the sheet P is discharged into a delivery tray (unshown), which is outside the main assembly of the image forming apparatus 100.

Meanwhile, the toner (primary transfer residual toner) which is remaining on the photosensitive drum 1 after the primary transfer is charged by the auxiliary charge roller 6 which is an auxiliary charging means. Then, it is charged by the charge roller 2. Thereafter, it is recovered by the developing apparatus 4. Further, the image forming apparatus 100 is provided with a belt cleaner 11, as a means for cleaning the intermediary transfer belt 7, which is disposed on the outward side of the loop which the intermediary transfer belt 7 forms. The belt cleaner 11 is disposed in a position in which it opposes the tension roller 17 with the presence of the intermediary transfer belt 7 between the belt cleaner 11 and tension roller 17. The secondary transfer residual toner, or the toner remaining on the intermediary transfer belt 7 after the secondary transfer, is recovered by the belt cleaner 11.

### 2. Developing Apparatus

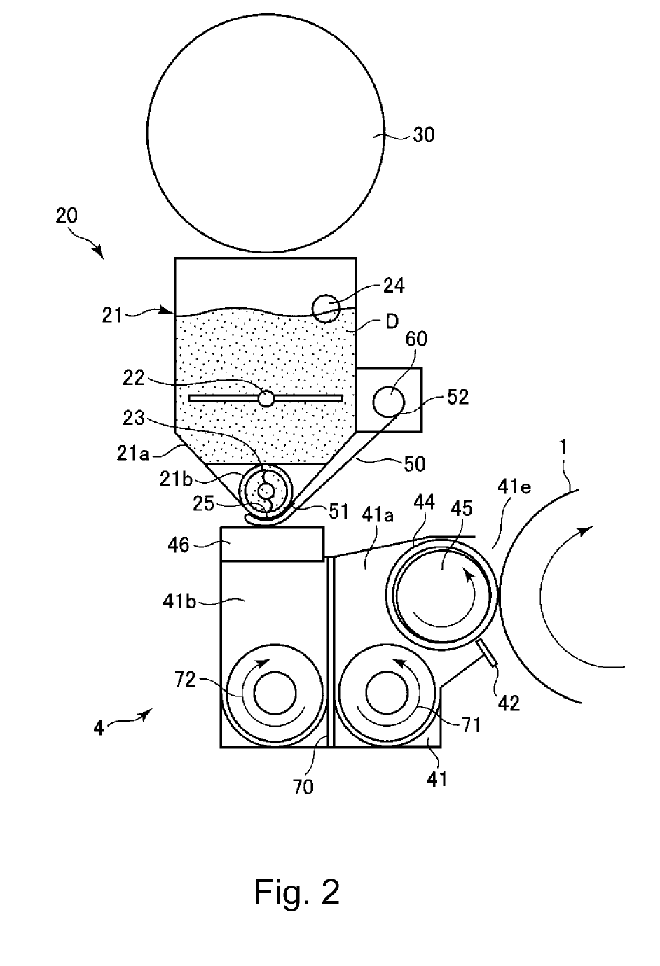

FIG. 2 is a schematic sectional view of the developing apparatus 4, and its adjacencies, in this embodiment, at such a vertical plane that is roughly perpendicular to the rotational axis of the photosensitive drum 1. The developing apparatus 4 has a developer container 41 in which two-component developer made up of toner (nonmagnetic toner particles) as developer, and carrier (magnetic carrier particles) is stored. The interior space of the developer container 41 is partitioned by a partition wall 70. That is, the developer container 41 is provided with a development chamber 41a, and a stirring chamber separated from the development chamber 41a by the partition wall 70. The development chamber 41a and stirring chamber 41b are shaped and positioned so that their lengthwise direction is roughly parallel to the rotational axis of the photosensitive drum 1.

The development chamber 41a is provided with a development opening 41e, which faces the peripheral surface of the photosensitive drum 1. The developing apparatus 4 is provided with a development sleeve 44, as a developer bearing member, which is disposed in the development chamber 41a so that the development sleeve 44 is partially exposed toward the photosensitive drum 1 from the development chamber 41a through the opening 41e. The development sleeve 44 is rotatably supported by the developer container 41 so that its rotational axis is roughly parallel to the rotational axis of the photosensitive drum 1. It is rotationally driven in such a direction that the peripheral surface of the development sleeve 44 and that of the photosensitive drum 1 move in the same direction in the area (development position) in which the two surfaces are in contact, or virtually in contact, with each other. There is disposed a magnetic roll 45, as a magnetic field generating means, in the internal hollow of the development sleeve 44. The magnetic roll 45 is formed of a magnetic substance. It is nonrotationally supported by the developer container 41. Further, the developing apparatus 4 is provided with a development blade 42, as a developer regulating member, which is for forming a thin layer of developer on the peripheral surface of the development sleeve 44. The development blade 42 is shaped and disposed so that it extends along one of the long edges of the development opening 41e. The developer in the development chamber 41a is attracted by the magnetic force of the magnetic roll 45 in such a manner that it is born on the peripheral surface of the development sleeve 44 as the development sleeve 44 is rotated. Then, as the development sleeve 44 is rotated, the developer borne on the peripheral surface of the development sleeve 44 is regulated by the development blade 42, being thereby turned into a thin layer of developer having a preset thickness. Then, the thin layer of developer is supplied to the development position by the further rotation of the development sleeve 44. In the development position, the developer on the development sleeve 44 is made to crest (form magnetic brush) by the magnetic force of the magnetic roll 45, and comes into contact with, or virtually in contact, with, the peripheral surface of the photosensitive drum 1. Thus, the toner in the magnetic brush is adhered to the peripheral surface of the photosensitive drum 1 in the pattern of the electrostatic latent image formed on the peripheral surface of the photosensitive drum 1. The developer on the development sleeve 44, which moved past the development position, is returned to the development chamber 41a.

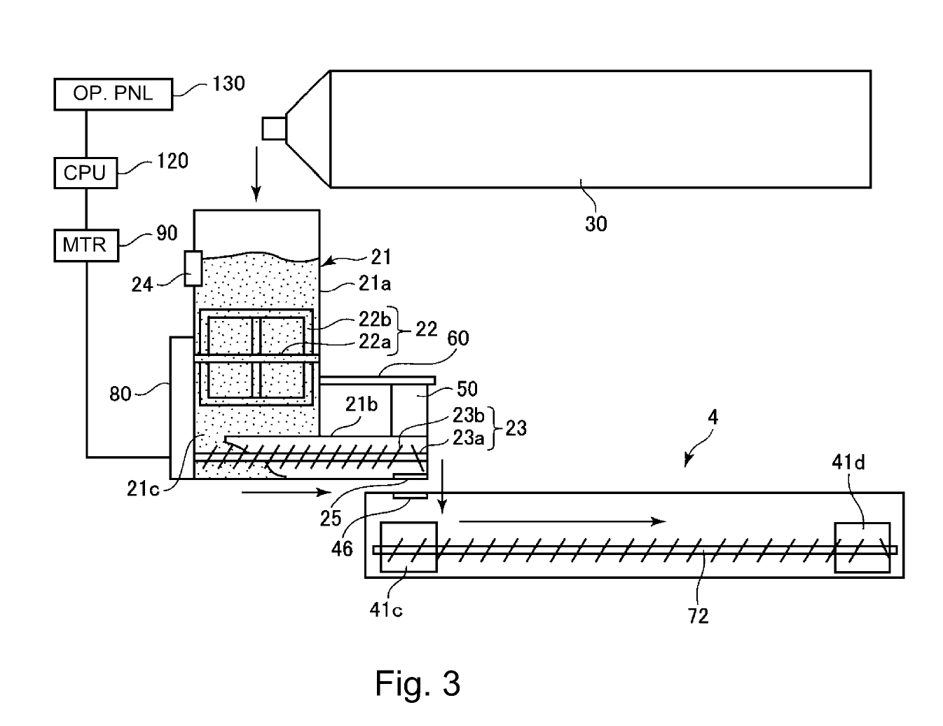

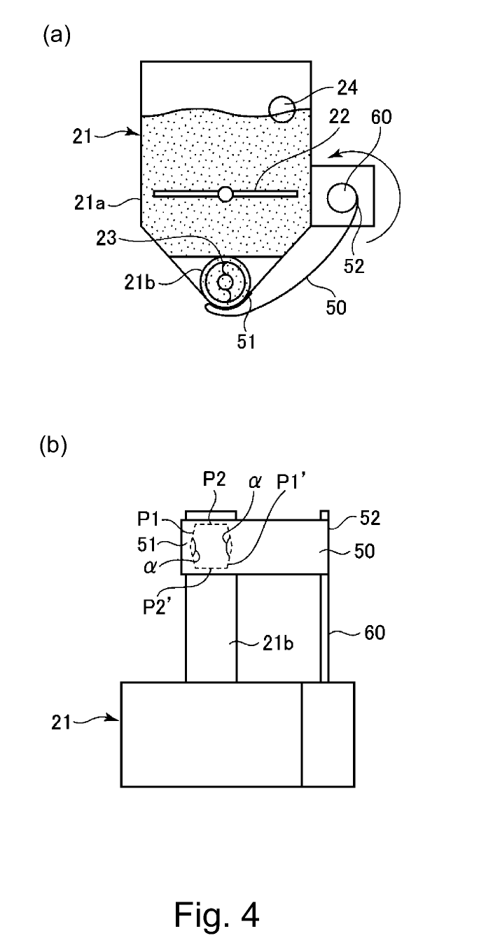

There is disposed the first conveying member 71 in the development chamber 41a. The first conveying member 71 conveys the developer in the development chamber 41a while stirring the developer. In the stirring chamber 41b, the second conveying member 72 is disposed, which conveys the developer in the stirring chamber 41b while stirring the developer. The first and second conveying members 71 and 72 are in the form of a screw made up of a rotational shaft and a spiral blade fitted around the rotational shaft. The rotational axis of the first conveying member 71 and that of the second conveying member 72 are roughly parallel to the rotational axis of the photosensitive drum 1. The first and second conveying members 71 and 72 convey the developer in the direction parallel to their rotational axis. However, they are opposite in the developer conveyance direction. The developer container 41 is provided with a developer passages 41c and 41d (FIG. 3), that is, a pair of openings through which the developer in the developer container 41 is moved between the development chamber 41a and stirring chamber 41b. The developer passages 41c and 41d are located at the lengthwise ends of the partition wall 70, one for one. Thus, as the first and second conveying members 71 and 72 are rotated, the developer in the developer container 41 is moved from the developer chamber 41a to the stirring chamber 41b through the developer passage 41d, and also, from the stirring chamber 41b to development chamber 41a through the developer passage 41c, being thereby circulated within the developer container 41.

Further, the stirring chamber 41b is provided with a developer reception opening 46, through which replenishment developer is received from a replenishing apparatus, which is described later. The developer reception opening 46 is located at the upstream end (which corresponds to back side of sheet of paper on which FIG. 2 is drawn) in terms of the direction in which developer is conveyed in the stirring chamber 41b. It is the top side of the wall of the stirring chamber 41b that is provided with the developer reception opening 46.

### 3. Basic Structure of Replenishing Apparatus

Referring to FIG. 2, the image forming apparatus 100 is provided with a hopper unit 20, as a replenishing apparatus, which temporarily stores toner D as replenishment developer. More concretely, toner D or the replenishment developer is supplied to the hopper unit 20 from a toner bottle 30 as the developer container. As the toner D is supplied to the hopper unit 20, the unit 20 temporarily stores the toner D. The hopper unit 20 is provided with a developer container 21 as a developer storing portion. In this embodiment, the developer container 21 has the first section 21a and second section 21b. The first section 21a is the section in which a stirring member 22 and a residual amount sensor 23, which are described later, are disposed. The second section 21b is disposed on the bottom side of the first section 21a. It is the section in which a conveying member 23, which also is described later, is disposed. The first section 21a and second section 21b are in connection with each other through a passage 21c (opening) (FIG. 3).

In the first section 21a of the developer container 21 of the hopper unit 20, the stirring member 22 for stirring the toner D in the developer container 21 is disposed. In this embodiment, the stirring member 22 has a rotatable shaft 22a, and a paddle 22b which is the actual stirring portion attached to the shaft 22a. The paddle 22b is made up of ribs. The rotational axis of the shaft 22a is roughly parallel to the rotational axis of the photosensitive drum 1. The paddle 22 is made up of two sections which oppose each other across the shaft 22a. Each section of the paddle 22 has a pair of radial subsections which extend from the shaft 22a in the radius direction of the shaft 22a, and a subsection which is parallel to the shaft 22a and is in connection to the opposite end of each radial subsection. As the stirring member 22 is rotated, the toner D in the developer container 21 is stirred by the stirring member 22.

In the second section 21b of the developer container 21 of the hopper unit 20, the aforementioned conveying member 23 for conveying the toner D in the developer container 21 toward the developing apparatus 4 is disposed. In this embodiment, it is a screw-like member which is made up of a rotational shaft 23a, and a spiral blade, as an actual conveying portion, spirally attached to the shaft 23a. The rotational axis of the conveying member 23 is roughly parallel to the rotational axis of the photosensitive drum 1. The aforementioned passage 21c (opening) (FIG. 3) between the first and second sections 21a and 21b of the developer container 21 of the hopper unit 20 is located at the upstream end (rear side of sheet of paper on which FIG. 2 is drawn) in terms of the direction in which toner is conveyed by the conveying member 23. Further, the second section 21b of the developer container 21 of the hopper unit 20 is provided with a developer delivery opening 25, which is a connective portion for providing a developer passage between the developer container 21 of the hopper unit 20, and developing apparatus 4. The developer delivery opening 25 is located at the upstream end (front side of sheet of paper on which FIG. 2 is drawn) of the second section 21b in terms of the toner conveyance direction of the conveying member 23. It is the bottom portion of the wall of the developer container 21 (section 21b, to describe in detail) of the hopper unit 20 that is provided with the developer delivery opening 25. The image forming apparatus 100 is structured so that after the proper placement of the developing apparatus 4 and hopper unit 20 in the main assembly 110 of the image forming apparatus 100, the developer delivery opening 25 of the hopper unit 20 and the developer reception opening 46 of the developing apparatus 4 align with each other in the gravity direction. As the toner D is conveyed by the conveying member 23, it falls into the stirring chamber 41b of the developing apparatus 4 through the developer delivery opening 25 and developer reception opening 46, whereby the stirring chamber 41b is supplied with the toner D.

In the first section 21a of the developer container 21 of the hopper unit 20, the residual amount sensor 24 for detecting the residual amount of toner D in the developer container 21 of the hopper unit 20 is disposed as a residual amount detecting means. In this embodiment, the residual amount sensor 24 is a piezoelectric sensor. To the developer container 21 of the hopper unit 20, the toner D is supplied from the toner bottle 30 in response to the residual amount of toner D in the developer container 21 detected by the sensor 24, to ensure that roughly the preset amount of toner D remains in the developer container 21. The toner bottle 30 is removably installable in the apparatus main assembly 110. After the installation of the toner bottle 30 into the apparatus main assembly 110, the toner bottle 30 remains in connection to the developer container 21. As the toner bottle 30 in the apparatus main assembly 110 runs out of the toner, it is replaced by a brand-new one.

Since the image forming apparatus 100 is structured as described above, as toner is delivered from the toner bottle 30 to the developer container 21 of the hopper unit 20, it is stirred by the stirring member 22 in the developer container 21, and then, is supplied to the stirring chamber 41b of the developing apparatus 4 by the conveying member 23.

By the way, in this embodiment, the developing apparatus 4 is removably installable in the apparatus main assembly 110. The developing apparatus 4 is provided with a shutter (unshown), which can keep closed the developer reception opening 46 as the developing apparatus 4 is removed from the apparatus main assembly 110. This shutter opens the developer reception opening 46 as the developing apparatus 4 is installed into the apparatus main assembly 110. In this embodiment, the developing apparatus 4 filled with the initial supply of developer is installed into the apparatus main assembly 100 before the image forming apparatus 110 is shipped.

Further, the toner bottle 30 is provided with a sealing member (unshown), which keeps sealed, the toner outlet of the toner bottle 30, which becomes connected to the hopper unit 20 as the toner bottle 30 is installed into the apparatus main assembly 110. Further, the hopper unit 20 is provided with an unsealing apparatus (unshown) for removing the sealing member of the toner bottle 30. The unsealing apparatus removes the sealing member of the toner bottle 30 as the toner bottle 30 is installed into the apparatus main assembly 110. It is not mandatory that the toner bottle 30 is installed into the apparatus main assembly 110 before the image forming apparatus 100 is shipped; the toner bottle 30 does not need to be installed in the apparatus main assembly 110 before the image forming apparatus 100 is shipped from its factory. In a case where the toner bottle 30 is not installed in the apparatus main assembly 110 before the image forming apparatus 100 is shipped from the factory, the toner bottle 30 is to be installed into the apparatus main assembly 110 before the image forming apparatus 100 is started up for the first time as will be described later. In a case where the toner bottle 30 is installed into the apparatus main assembly 110 before the image forming apparatus 100 is shipped from a factory, it is possible that toner will flow into the hopper unit 20 from the toner bottle 30 because of the vibrations or the like which occur during the shipment. Such an occurrence is not problematic because the image forming apparatus 100 is structured so that a proper amount of toner is supplied from the hopper unit 20 to the developing apparatus 4 after the image forming apparatus 100 begins to be operated. However, the image forming apparatus 100 may be designed so that the sealing member of the toner bottle 30 is not removed by the unsealing apparatus until the image forming apparatus 100 is started up for the first time as will be described later.

### 4. Structure of Mechanism for Driving Replenishing Apparatus

FIG. 3 is a schematic sectional view of the hopper unit 20, and its adjacencies, at a vertical plane (which is roughly parallel to the rotational axis of the photosensitive drum 1). Part (a) of FIG. 4 is a schematic vertical sectional view of the hopper unit 20 and its adjacencies, and part (b) of FIG. 4 is a schematic bottom view of the hopper unit 20 and its adjacencies. They show the structure of the mechanism for driving the hopper unit 20.

The hopper unit 20 is provided with a driving portion 80, which transmits driving force to the rotational members (stirring member 22, conveying member 23, and take-up shaft 60 (which is described later) with which the hopper unit 20 is equipped). To the driving portion 80, driving force is transmitted from a motor 90, as a driving force source, with which apparatus main assembly 110 is provided. The motor 90 is controlled by the control portion 120 (CPU) with which the apparatus main assembly 110 is provided. The control portion 120 is in connection to a control panel 130 with which the apparatus main assembly 110 is provided. In this embodiment, the control panel 130 is given the function of an inputting means for inputting information into the control portion 120, as well as the function of a displaying means controlled by the control portion 120 to display information to an operator.

The image forming apparatus 100 is structured so that the driving portion 80 can rotate the stirring member 22 without rotating the conveying member 23. That is, it is structured so that the hopper unit 20 is allowed to stir the toner in the developer container 21 of the hopper unit 20 without supplying the developing apparatus 4 with toner (without conveying toner toward developing apparatus 4). Further, the image forming apparatus 100 is structured so that as the driving portion 80 rotates the conveying member 23, the stirring member 22 is also rotated by the driving force from the driving portion 80. Not only is the driving portion 80 enabled to transmit driving force to the stirring member 22 and conveying member 23 to drive them, but also, is provided with a driving force transmitting member (gear, clutch, or the like) which makes it possible to prevent the driving force from the driving portion 80 from being transmitted to the conveying member 23, so that only the stirring member 22 is rotated. Further, the driving portion 80 is provided with a driving force transmitting member (gear or the like) which transmits the driving force to both the stirring member 22 and take-up shaft 60 to rotate both.

### 5. Structural Arrangement to Keep Replenishing Apparatus Sealed

The image forming apparatus 100 in this embodiment is shipped after the developing apparatus 4 and hopper unit 20 is installed in the apparatus main assembly 110, and toner (toner D) is stored in the hopper unit 20. To describe in detail, “image forming apparatus is shipped (from factory)” means that a completely, or partially, finished image forming apparatus is transported out of the factory or the like after at least the developing apparatus 4, and the replenishing apparatus filled with developer, are disposed in the preset positions in the apparatus main assembly 110 in the factory or the like.

In a case where the image forming apparatus 100 is shipped after the developing apparatus 4 is installed in the apparatus main assembly 110, the shutter for keeping the developer delivery opening 25 of the hopper unit 20 closed, and the shutter for keeping the developer reception opening 46 of the developing apparatus 4 closed, are kept open. Therefore, if the image forming apparatus 100 is shipped in such a state that the hopper unit 20 contains toner, it is possible that the vibrations or the like, which occur during the shipment, will cause the toner in the hopper unit 20 to flow into the developing apparatus 4. Besides, even if the developing apparatus 4 is provided with the sealing member for keeping sealed the developer reception opening 46 of the developing apparatus 4, it is possible that as the image forming apparatus 100 is shipped after the filling of the hopper unit 20 with toner, the developer scatters from the developer delivery opening 25 because of the vibrations or the like which occur during the shipment.

In this embodiment, therefore, the image forming apparatus 100 is structured so that the hopper unit 20 is provided with a sealing member 50 for keeping sealed the developer delivery opening 25, as the developer passage to the developing apparatus 4, of the hopper unit 20. Moreover, the image forming apparatus 100 is provided with a removing means for removing the sealing member 50 from the developer delivery opening 25 so that a developer passage is established between the developer container 21 of the hopper unit 20, and developing apparatus 4. In this embodiment, the removing means removes the sealing member 50 when the hopper unit 20 is operated form the first time. In this embodiment, the sealing member 50 is a long and narrow sheet of film. The removing means has a rotational member which can be rotated to take up the sealing member 50. Further, in this embodiment, this rotatable member is disposed outside the developer container 21 of the hopper unit 20. It removes the sealing member 50, which is keeping sealed the developer delivery opening 25 of the hopper unit 20, from outside the container 21. Next, this process of removing the sealing member 50 is described in detail.

Referring to FIGS. 2 and 3, when the image forming apparatus 100 is shipped from its factory or the like, the developer delivery opening 25 of the hopper unit 20 is remaining sealed by the sealing member 50, and toner as replenishment developer is remaining hermitically sealed in the developer container 21 of the hopper unit 20. In this embodiment, the sealing member 50 is in the form of a piece of long and narrow belt-like member. It is pasted by the lengthwise end 51 (one of its lengthwise end portions) to the fringe portions of the developer delivery opening 25 of the hopper unit 20, in such a manner that it can be peeled away (that developer delivery opening 25 can be unsealed). In this embodiment, it is welded to the developer container 21 of the hopper unit 20. More specifically, first, the lengthwise end portion 51 (one of its lengthwise end portions) of the sealing member 50 is welded to the fringe portion of the developer delivery opening 25, starting from the right end side of the developer delivery opening 25, and then, toward the left end side of the opening 25 to seal the developer delivery opening 25. Then, it is folded back, and the other lengthwise end 52 (one of lengthwise end portions) is fixed to the aforementioned take-up shaft 60, as a rotatable member, of the removing means (sealing member moving mechanism, unsealing mechanism).

The take-up shaft 60 takes up the sealing member 50 by being rotated by the driving force transmitted thereto from the driving portion 80. In this embodiment, the take-up shaft 60 is rotated with the stirring member 22 to take up the sealing member 50. As the take-up shaft 60 is rotated, the sealing member 50 is peeled away from the periphery of the developer delivery opening 25, whereby the developer delivery opening 25 is unsealed. Consequently, the developer container 21 of the hopper unit 20 and developing apparatus 4 become connected to each other through the developer delivery opening 25 and developer reception opening 46. That is, the sealing member 50 is automatically peeled away by the take-up shaft 60 as described above to start up the hopper unit 20 so that a developer passage is established from the hopper unit 20 to the developing apparatus 4.

In this embodiment, the timing with which the peeling of the sealing member 50 is to be started is set so that it coincides with the timing with which the driving of the hopper unit 20 is started. That is, as the image forming apparatus 100 is turned on to be started up, the stirring member 22 of the hopper unit 20 begins to be rotated to begin stirring the toner in the developer container 21 of the hopper unit 20. Further, the take-up shaft 60 begins to be rotated to take up the sealing member 50, at the same time as stirring member 22. By the way, the timing with which the sealing member 50 begins to be removed is described later in detail.

Part (a) of FIG. 4 is a schematic sectional view of the hopper unit 20, at a vertical plane (which is roughly perpendicular to rotational axis of photosensitive drum 1). It shows how and where the hopper unit 20 is kept sealed. Part (b) of FIG. 4 is a schematic bottom view of the hopper unit 20 as seen from the developer delivery opening 25 side. It shows also how the hopper unit 20 is kept sealed.

In this embodiment, the sealing member 50 is 100 mm in length. Also in this embodiment, a thin sheet of a resinous substance (including polyester), which is 0.1 mm in thickness, was used as the material for the sealing member 50. Referring to part (a) of FIG. 4, the lengthwise end portion 51 of the sealing member 50 is welded to the periphery of the developer delivery opening 25 of the developer container 21 of the hopper unit 20, and the other 51 is fixed to the take-up shaft 60.

Referring to part (b) of FIG. 4, the lengthwise end portion 51 of the sealing member 50 is welded to a vertical collar made up of a pair of vertical (with reference to part (b) of FIG. 4 portions P1 and P1′ and a pair of horizontal (with reference to part (b) of FIG. 4) portions P2 and P2,′ with which the developer container 21 of the hopper unit 20 is provided, and which surrounds the developer delivery opening 25. That is, the pair of vertical portions P1 and P1′ of the collar are the portions of the developer container 21, to which the sealing member 50 is welded, and which are parallel to the rotational axis of the photosensitive drum 1. The pair of portions P2 and P2′ of the vertical collar are the portions of the developer container 21, to which the sealing member 50 is also welded, and which are roughly perpendicular to the rotational axis of the photosensitive drum 1. Further, the pair of horizontal portions P2 and P2′ are bent in such a manner that the distance between their lengthwise center portion is greater than the distance between their lengthwise end portions. The angle α between one half of the horizontal portion P1 (P1′) and the other half is obtuse (90°<α<180°). The amount of force necessary to peel the sealing member 50 away from the pair of vertical portions P1 and P1′ of the collar is greater than that from the pair of horizontal portions P2 and P2′. Thus, the pair of horizontal portions P1 and P1′ are bent roughly at their center by an angle α mentioned above, in order to reduce the amount of force necessary to peel the sealing member 50 away from the pair of horizontal portions P1 and P1′ of the vertical collar.

Further, in this embodiment, the sealing member 50 is made longer than necessary by 10 mm; it is allowed to remain slackened until it is peeled away. That is, the sealing member 50 begins to be peeled away from the left horizontal portion P1 (parts (a) and (b) of FIG. 4) of the vertical collar as the take-up shaft 60 takes up the sealing member 50 by 10 cm.

### 6. Initial Startup Sequence

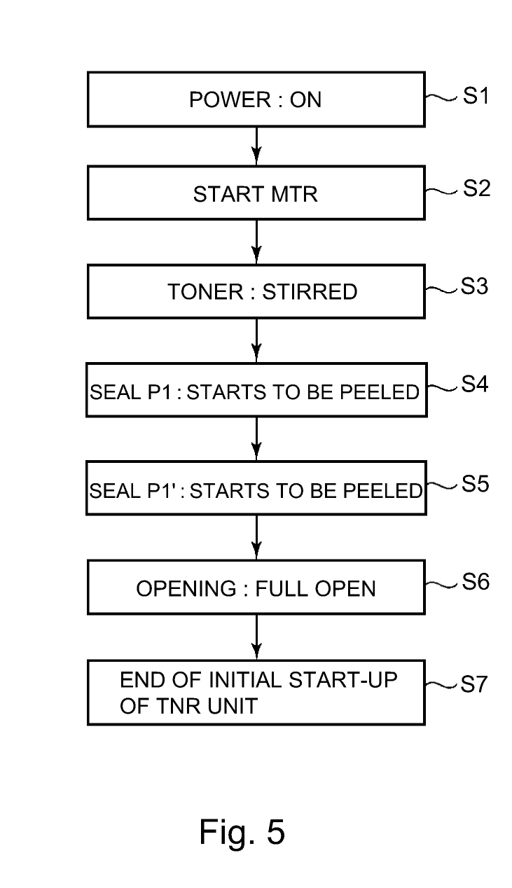

FIG. 5 is a flowchart of the operational sequence to be carried out to start up the hopper unit 20 when the image forming apparatus 100 is started up for the first time.

First, the image forming apparatus 100 is turned on by an operator (S1). Then, as an instruction to make the image forming apparatus 100 start up the hopper unit 20 is inputted by the operator with the use of the control panel 30, the control portion 120 begins to rotate the motor 90 in the preset direction (S2). Thus, not only the stirring member 22 of the hopper unit 20 begins to rotate, but also, the take-up shaft 60 begins to rotate with the stirring member 22. By the way, the image forming apparatus 100 may be designed so that as the image forming apparatus 100 is turned on, the operational sequence for initializing the hopper unit 20 is automatically started.

As the stirring member 22 begins its rotation, the toner in the developer container 21 of the hopper unit 20 begins to be stirred (S3). At this point in time, the conveying member 23 does not rotate. Therefore, the toner in the hopper unit 20 is not conveyed toward the developing apparatus 4. Further, as the take-up shaft 60 begins to rotate, the sealing member 50 begins to be taken up by the take-up shaft 60. Thus, the sealing member 50 begins to be peeled away from the left horizontal portion P1 (parts (a) and (b) of FIG. 4) (S4) of the vertical collar. At this point in time, the amount of force necessary to peel the horizontal portion P1 adds to the amount of force necessary to take up the sealing member 50 while the sealing member 50 is remaining slackened. Thus, the amount of force (torque) required by the motor 90 temporarily increases from 0.10 N·m, which is the amount of torque, which the motor 90 is required to generate when the image forming apparatus 100 is being used for an ordinary task (after unsealing of developer container 21 of hopper unit 20). In this embodiment, the sealing member 50 is provided with a slack which is equivalent to 10 mm. Therefore, the sealing member 50 begins to be peeled away from the horizontal portion P1 of the vertical collar roughly 2 seconds after the take-up shaft 60 begins to rotate. Further, in this embodiment, as the sealing member 50 began to be peeled from the horizontal portion P1 of the collar, the amount of torque required of the motor 90 increased to as high as 0.27 N·m. Then, as soon as the sealing member 50 was completely peeled away from the horizontal portion P1, the amount of torque reduced to roughly 0.10 N·m, which is the normal amount of toque required during a normal image forming operation.

Then, the sealing member 50 continues to be taken up by the take-up shaft 60. Eventually, it begins to be peeled away from the right horizontal portion P1′ of the vertical collar (S5). At this point in time, the amount of torque necessary to peel the sealing member 50 from the right horizontal portion P′ adds to the amount of torque required of the motor 90 up to this point. Thus, the amount of torque required of the motor 90 temporarily increases compared to 0.10 N·m, or the amount of torque required of the motor 90 during a normal image forming operation. In this embodiment, as the sealing member 50 began to be peeled away from the right horizontal portion P1′, the amount of torque required of the motor 90 increased to 0.3 N·m. Then, as soon as the sealing member 50 was completely peeled away from the right horizontal portion P1, the amount of torque decreased to roughly 0.10 N·m, or the amount of torque required of the motor 90 during a normal image forming operation. By the way, the maximum amount of torque (peak torque) required of the motor 90 was the amount of torque required to peel the sealing member 50 from the right horizontal portion P1′.

As the welded portion of the sealing member 50 is completely peeled, the developer delivery opening 25 becomes fully open. Thus, the developer container 21 of the hopper unit 20, and the developing apparatus 4 become connected to each other through the developer delivery opening 25 and developer reception opening 46 (S6). Regarding the length of time the take-up shaft 60 is rotated, as a preset length of time (which in this embodiment is roughly 60 seconds) elapses after the stirring member 22 and take-up shaft 60 begin to be rotated, the stirring member 22 and take-up shaft 60 are stopped (S7). By the time the stirring member 22 and take-up shaft 60 are stopped, the sealing member 50 is completely taken up. This concludes the operational sequence for starting up the hopper unit 20 for the first time. Then, the hopper unit 20 is kept on standby.

By the way, in this embodiment, in consideration of the manner in which the sealing member 50 is taken up by the take-up shaft 60, a thin (0.1 mm thick) sheet of resinous substance (which includes polyester) was used as the material for the sealing member 50. However, this embodiment is not intended to limit the material and shape of the sealing member 50 to those in this embodiment. Further, this embodiment is not intended to limit the timing with which the unsealing of the developer delivery opening 25 is to be started, to that in this embodiment. By the way, the amount of force required to peel the sealing member 50 tends to become greater when the sealing member 50 begins to be peeled, and toward the end of the peeling. Therefore, the image forming apparatus 100 may be designed so that the rotation of the stirring member 22 is started after the sealing member 50 is completely peeled.

As described above, the image forming apparatus 100 in this embodiment is shipped from its manufacture or the like, with its hopper unit 20 filled with toner, and the developer delivery opening 25 of the hopper unit 20 sealed with the sealing member 50. Further, the sealing member 50 is automatically removed during the operational sequence carried out by the image forming apparatus 100 when the image forming apparatus 100 is initialized for the first time.

As described above, according to this embodiment, the hopper unit 20 is filled with toner before the image forming apparatus 100 is shipped from its manufacturer or the like. Therefore, it is unnecessary to deliver toner to the hopper unit 20 from the toner bottle 30 when the image forming apparatus 100 is started up for the first time. That is, this embodiment can reduce the amount of time necessary to start up an image forming apparatus for the first time.

Further, according to this embodiment, the developer delivery opening 25 of the hopper unit 20 is sealed with the sealing member 50 by a manufacturer or the like of the image forming apparatus 100. Therefore, even if the image forming apparatus 100 is shipped with its hopper unit 20 filled with toner, it does not occur that toner flows into the developing apparatus 4 from the hopper unit 20 during the shipment of the image forming apparatus 100. That is, this embodiment can prevent the problem that the toner leakage from the hopper unit 20 into the developing apparatus 4, which occurs during the shipment of the image forming apparatus 100, makes the developing apparatus 4 excessively high in toner density, and causes the image forming apparatus 100 to output unsatisfactory images when the apparatus 100 is used for the first time. Further, this embodiment can prevent the problem that toner scatters from the developer delivery opening 25 during the shipment of the image forming apparatus 100, and therefore, can prevent the problem that the image forming apparatus 100 output unsatisfactory images, unsatisfactoriness of which is attributable to the toner leakage from the hopper unit 20 into the developing apparatus 4, which occurs during the shipment of the image forming apparatus 100.

Moreover, according to this embodiment, the sealing member 50 is automatically removed by the take-up shaft 60, which is driven by the motor 90. Therefore, it is unnecessary for an operator to manually remove the sealing member 50 before the image forming apparatus 100 is used for the first time. Therefore, it is possible to prevent the following problem. Because the operator forgot to remove the sealing member 50, an image forming operation is started without the replenishment of the developing apparatus 4 with toner. Thus, the developer in the developing apparatus 4 gradually reduces in toner density, causing thereby the image forming apparatus 100 to output unsatisfactory images, that is, images which are abnormally low in toner density. As described above, according to this embodiment, it is possible to reduce an image forming apparatus in the number of steps an operator of the image forming apparatus is required to take when the image forming apparatus 100 is initialized for the first time.

### Embodiment 2

Next, the second embodiment of the present invention is described. The image forming apparatus in this embodiment is the same in basic structure as that in the first embodiment. Thus, the elements of the image forming apparatus in this embodiment, which are the same as, or correspondent to, the counterparts in the first embodiment, in function and structure, are given the same referential codes as those given to the counterparts, one for one, and are not described in detail.

In this embodiment, the rotational member which is the means for removing the sealing member 50 is disposed in the developer container 21 of the hopper unit 20 so that the sealing member 50, which keeps the developer container 21 of the hopper unit 20 sealed to keep the developer passage between the hopper unit 20 and developing apparatus 4, is removed from within the developer container 21. In this embodiment, however, after the sealing member 50 is taken up by the rotational member, at least a part of the sealing member 50 functions as the stirring member for stirring the developer in the hopper unit 20.

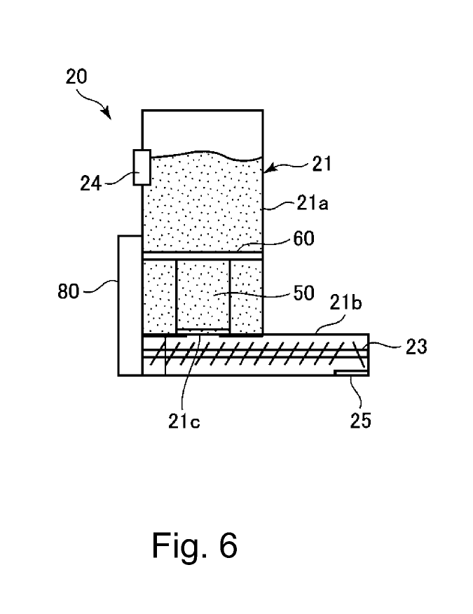

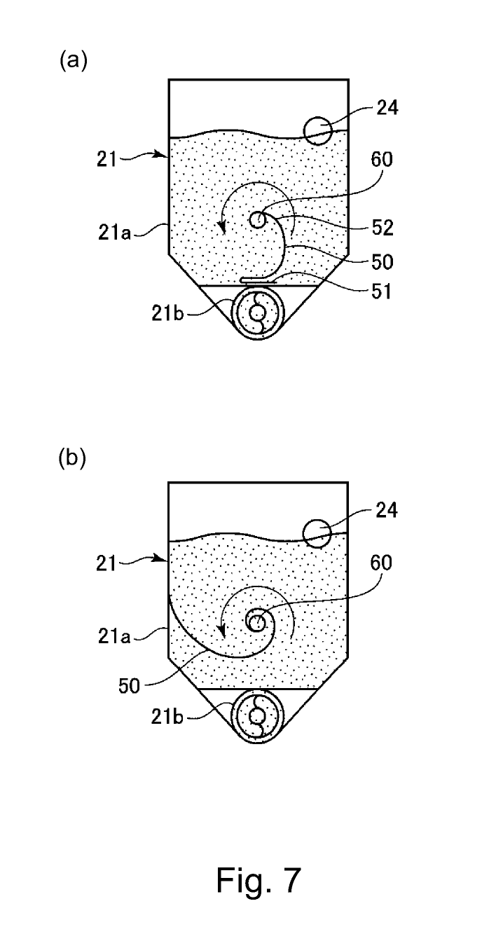

FIG. 6 is a schematic sectional view of the hopper unit 20 in this embodiment, at a vertical plane which is parallel to the side walls of the hopper unit 20 (at vertical plane which is roughly parallel to rotational axis of photosensitive drum 1). Parts (a) and (b) of FIG. 7 are schematic sectional views of the hopper unit 20 in this embodiment, at a vertical plane which is parallel to the front wall of the hopper unit 20, as seen from the front side of the hopper unit 20. Part (a) of FIG. 7 shows the state of the hopper unit 20 before the sealing member 50 is removed, and part (b) of FIG. 7 shows the state of the hopper unit 20 after the removal of the sealing member 50.

Referring to FIG. 6, in this embodiment, the sealing member 50 is welded to the inward wall of the first section 21a of the developer container 21 of the hopper unit 20. More specifically, it is welded to the periphery of the opening 21c (developer passage) of the developer container 21. The opening 21c (developer delivery opening) makes up a part of developer passage through which the developer container 21 and developing apparatus 4 become connected to each other. Referring to part (a) of FIG. 7, the sealing member 50 is welded to the developer container 21 in such a manner that first, the lengthwise end portion 51 (one of the lengthwise end portions) of the sealing member 50 is welded to the edge of the developer delivery opening 21c, starting from the right edge and extending toward the left edge, to cover the opening 21c, and then, it is folded back (rightward), whereas the other lengthwise end portion 52 is fixed to the take-up shaft 60 in the developer container 21. The take-up shaft 60 takes up the sealing member 50 by being rotated by the driving force transmitted thereto from the driving portion 80. Thus, the sealing member 50 is peeled away from the periphery of the developer delivery opening 21c, unblocking thereby the developer delivery opening 21c. Consequently, a developer passage is provided between the developer container 21 (first section 21a, to be more specific) of the hopper unit 20 through the developer delivery opening 21c, developer delivery opening 25, and developer reception opening 46. That is, as the image forming apparatus 100 is started up for the first time, the sealing member 50 is automatically peeled away by the take-up shaft 60 to provide a developer passage between the hopper unit 20 and developing apparatus 4.

Next, referring to FIG. 7(b) part (b) of FIG. 7, the sealing member 50 continues to be taken up even after it is completely moved away from the developer delivery opening 21c. However, the lengthwise end portion 51 (one of lengthwise end portions) of the sealing member 50 is not completely taken up by the take-up shaft 60 because of the elasticity of the sealing member 50 itself. That is, the lengthwise end portion 51 remains protrusive in the radius direction of the take-up shaft 60. Thus, as the take-up shaft 60 is rotated, this protrusive lengthwise end portion of the sealing member 50 rotates with the take-up shaft 60 in the developer container 21 of the hopper unit 20, stirring thereby the toner D in the developer container 21. As described above, in this embodiment, after the operation to take up the sealing member 50 is completed, at least a part of the sealing member 50 functions as a stirring member for stirring the toner D in the developer container 21.

As in the first embodiment, the timing with which the sealing member 50 begins to be peeled in this embodiment is set to coincide with the timing with which the hopper unit 20 begins to be driven. That is, as the image forming apparatus 100 is turned on when the image forming apparatus 100 is started up for the first time, the take-up shaft 60 of the hopper unit 20 begins to be rotated to start taking up the sealing member 50. Then, after the operation to take up the sealing member 50 is completed, the toner in the developer container 21 of the hopper unit 20 is stirred by the sealing member 50.

By the way, in this embodiment, the image forming apparatus 100 is structured so that after the completion of the operation to take up the sealing member 50, the sealing member 50 is utilized as the stirring member for stirring the toner in the developer container 21 of the hopper unit 20. This embodiment, however, is not intended to limit the present invention in scope in terms of the structure of an image forming apparatus. For example, the present invention is also applicable to an image forming apparatus provided with such a stirring member as the one in the first embodiment, which is in the form of a paddle having ribs, in addition to the sealing member 50. The present invention is also applicable to an image forming apparatus, the sealing member of which is not required to function as a stirring member. Moreover, in this embodiment, the opening 21 (developer passage) between the first and second sections 21a and 21b, respectively, was kept blocked by the sealing member 50 until the image forming apparatus 100 is started up for the first time. This embodiment, however, is not intended to limit the present invention in scope in terms of where the developer passage is blocked by the sealing member 50. For example, the present invention is also applicable to an image forming apparatus structured so that the developer delivery opening 25, which is adjacent to the developer reception opening 46 of the developing apparatus 4 is kept blocked from the inward side of the developer container 21 of the hopper unit 20, as in the first embodiment. In this case, all that is necessary is to provide the portion of the image forming apparatus, which is equivalent to the second section 21b in the first embodiment, with the take-up shaft 60.

As described above, according to this embodiment, not only is it possible to obtain the same effects as those obtainable by the first embodiment, but also, to simplify the hopper unit 20 in structure. Therefore, it is possible to reduce the hopper unit 20 in component count, which in turn makes it possible to reduce the hopper unit 20 in cost and size.

### [Miscellanies]

In the foregoing, the present invention was described with reference to a couple of preferred embodiments of the present invention. However, the preceding embodiments are not intended to limit the present invention in scope.

In the preceding description of the present invention, the replenishment developer was described as pure toner. However, the present invention is compatible with a case in which the replenishment developer is such two-component developer (that is greater in toner ratio than developer in developing apparatus) made up of toner and carrier.

Further, in the above-described embodiments, the image forming apparatus was a color image forming apparatus having multiple image forming portions. However, the present invention is also applicable to a monochromatic image forming apparatus having only an image forming portion for a black image. The effects of such application is the same as those obtainable by the preceding embodiment described above.

Further, not only is the present invention applicable to an image forming apparatus which uses two-component developer, but also, an image forming apparatus which uses single-component developer, that is, developer which does not contain carrier. Effects of such application are the same as those obtainable by the preceding embodiments described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-006987 filed on Jan. 18, 2017, which is hereby incorporated by reference herein in its entirety.

What is claimed is:

1. An image forming apparatus, comprising:
a developing device configured to develop an electrostatic latent image formed on an image bearing member, said developing device being detachably mounted to an image forming apparatus;
a supplying device including an accommodating portion configured to accommodate a developer supplied from a developer container accommodating the developer, said supplying device being configured to supply the developer accommodated in said accommodating portion into said developing device;
a controller configured to control the supply of the developer from said supplying device into said developing device;
a communicating portion provided in said supplying device and configured for fluid communication between said accommodating portion and said developing device;
a seal provided at said communicating portion to hermetically confining the developer in said accommodating portion before an operation of image forming apparatus; and
a removing portion configured to receive a driving force from said image forming apparatus to wind said seal up to permit fluid communication between said accommodating portion and said developing device.

2. An apparatus according to claim 1, wherein said removing portion winds up and removes said seal at the time of an initial operation of said supplying device.

3. An apparatus according to claim 1, wherein said removing portion includes a rotatable rotation shaft configured to wind said seal up.

4. An apparatus according to claim 3, wherein said shaft disposed outside of said accommodating portion.

5. An apparatus according to claim 3, wherein said shaft disposed in said accommodating portion.

6. An apparatus according to claim 5, wherein said shaft also functions to stir the developer in said supplying device.

7. An apparatus according to claim 1, further comprising a developer accommodation bottle detachably mountable to said image forming apparatus and configured to accommodate the developer.
